(19) United States
(12) Patent Application Publication
(10) Pub. No.: US 2006/0007056 A1
(43) Pub. Date: Jan. 12, 2006

(54) Head mounted display system having virtual keyboard and capable of adjusting focus of display screen and device installed the same

(76) Inventor: Shu-Fong Ou, Taipei Hsien (TW)

Correspondence Address: Shu-Fong Ou, Box 8-24, 235 Chung-Ho, Taipei, TW

(21) Appl. No.: 10/887,444

(22) Filed: Jul. 9, 2004

(51) Int. Cl. G09G 5/00

(52) U.S. Cl. 345/8

(57) ABSTRACT

A head mounted display system having a virtual keyboard and capable of adjusting a focus of a display screen comprises a signal processing unit; a focus adjustment unit; an image display unit connected to the signal processing unit; the image display unit being installed at a head mounted display device for displaying the adjusted display image which is directly viewed by at least one eye of a user wearing the head mounted display; and a focus input unit connected to the focus adjustment unit; focus input unit being a manually operation device for generating the focus adjustment signal to the signal processing unit; the focus input unit providing a focus value to the focus adjustment unit; and a virtual keyboard input unit including a finger positioning unit, a keyboard display unit, a keying processing unit and a virtual keyboard. The device for realizing the system is further included.

### FIELD OF THE INVENTION

The present invention relates to head mounted displays, and particular to a head mounted display system having a virtual keyboard and capable of adjusting focuses of display screens, and a device hazing the system. Thereby, the user can operated a head mounted display system with a convenient input device, and moreover the user has view clear images from the screen of the head mounted display.

### BACKGROUND OF THE INVENTION

In U.S. Pat. No. 6,369,952, a visual display device is provided for delivering a generated image, preferably combinable with environment light, to the eye of a user. A shroud protects from stray light and holds optical elements in desired alignment. An image generator is masked by at least two masks to provide for a high quality image without waste. A removably mounted shield or activatable device and convert the apparatus from a see-through device to an immersion device and back again. The device can be mounted to the user's head while still allowing for use of conventional eyeglasses. A tracker for outputting an indication of the orientation, attitude and/or position of a head-mounted display (HMD) may be provided. The tracker can be configured so that it is incorporated in the HMD housing and/or can be easily decoupled from the HMD, so that the HMD can be used without the tracker (e.g. for watching movies).

In U.S. Pat. No. 6,611,385, a wearable display system including a display panel to display a signal processed in a predetermined way. The wearable display system includes a grating to diffract a signal output from the display panel, a waveguide to guide the propagation of a signal diffracted by the grating; and a magnifying lens to magnify the signal propagating through the waveguide and to direct the signal toward an eye of a user. The waveguide is formed by a combination of two or more substrates. According to the wearable display system, optical devices are easily and simply arranged on the waveguide to conform to specifications, and furthermore, are individually manufactured and attached to the waveguide. Therefore, the wearable display system is manufactured with minimum time and effort.

In U.S. Pat. No. 5,991,084, a compact virtual image display system is provided, which includes a microdisplay; a first magnification optic consisting of three surfaces: a display input surface; a reflective/transmissive surface, and a reflective first magnification element surface; and a second magnification optic. Light forming the source object enters the first magnification optic at the display input surface. The light travels within the first magnification optic such that it is projected to an area on the reflective backslash transmissive surface that is at least partially within the full field of view provided by the second magnification optic. The light is directed to the reflective/transmissive surface at a first angle relative to the reflective/transmissive surface such that the light is internally reflected by the reflective/transmissive surface and directed to the reflective first magnification element surface. The first magnification element surface internally reflects the light corresponding to the source object as a magnified virtual image. The magnified virtual image is then is conveyed within the first magnification optic back to the reflective/transmissive surface at a second angle of incidence relative to the reflective/transmissive surface such that the light is transmitted by the reflective/transmissive surface out of the first magnification optic. The second magnification optic is positioned to receive the magnified virtual image transmitted from the first magnification optic and transmit a compound magnified virtual image of the magnified virtual image of the source object to the observer.

In U.S. Pat. No. 6,683,584, a camera display system displays information via a matrix display element mounted within a housing that is positioned relative to at least eye of a user. The display is connected to a video or image sensor such that the user can view information or images shown on the display. The display can be mounted to a housing so that the user can move the display in and out of the user's field of view.

In U.S. Pat. No. 6,680,802, a one-eye viewing type head-mounted image display device that is compact and comfortably wearable consists mainly of a viewer and an elastic member. The viewer includes an LCD, a main prism, a see-through prism, a frame, and a microphone. The main prism conducts an image, which is displayed on the LCD, to make the image viewable with either the user's right eye or left eye. The see-through prism is bonded to the main prism, transmits extraneously light, and conducts the light to a users eye. The frame bears the LCD at a predetermined position relative to the prisms. The microphone is mounted in the frame. The elastic member includes a nose rest which supports the viewer so that the viewer will be located at a predetermined position in front of the user's eye.

However, all above mentioned prior arts only disclose optical systems or mechanic structures for displaying image to the head mounted display, but no prior art discusses or discloses any structure or mechanism about the keying of the present invention. However, some data is necessary to be inputted into the head mounted unit for communicated with the unit. Or the user can use the head mounted unit do some works so that the HMU can be operated as a computer. All these need an input structure, but to carry a keyboard or a mouse with the HMU is very inconvenient.

Moreover, no above mentioned prior art discloses any structure about the image quality to the eyes. Many people have eye diseases, such as far-sightedness (hyperopia), nearsightedness (shortsightedness; myopia), weak sight (amblyopia), or astigmatism, which cannot see clear views for normal images. Thereby, as a normally clean image is displayed on a head mounted unit, the image is vague to the eye-diseased user. This is because it is not imaged in the focus of the user. For example, the image of a nearsighted people is focused before the retina so that the people will see a vague image. For example, nearsighted people must wear a pair of eyeglasses to adjust the image clearness to make the image is just imaged on the retina. However, this problem is also occurred for the people wearing a head mounted display since in general, the user wearing a head mounted display can not further wear a pair of glasses. Thus, it is necessary that the image displayed on the head mounted display can provide images suitable for the eyes of the user. Thus it is necessary to that the images displayed on the head mount display is adjusted in advance so that as the image is incident in to the eyes it present a clear image on the retina of the user's eyes.

### SUMMARY OF THE INVENTION

Accordingly, the primary object of the present invention is to provide a head mounted display system having a virtual keyboard and capable of adjusting a focus of a display screen, and a device having the system. Thereby, the user can operated a head mounted display system with a convenient input device, and moreove, the user can see a clear image from the screen of the head mounted display.

To achieve above objects, the present invention provides a head mounted display system having a virtual keyboard and capable of adjusting a focus of a display screen. The system comprises a signal processing unit; a focus adjustment unit; an image display unit connected to the signal processing unit; the image display unit being installed at a head mounted display device for displaying the adjusted display image which is directly viewed by at least one eye of a user wearing the head mounted display; and a focus input unit connected to the focus adjustment unit; focus input unit being a manually operation device for generating the focus adjustment signal to the signal processing unit; the focus input unit providing a focus value to the focus adjustment unit; and a virtual keyboard input unit including a finger positioning unit, a keyboard display unit, a keying processing unit and a virtual keyboard.

Moreover, the present invention provides a head mounted display device which can realize above mentioned system. The various objects and advantages of the present invention will be more readily understood from the following detailed description when read in conjunction with the appended drawing.

### BRIEF DESCRIPTION OF THE DRAWINGS

FIG. 1 shows a perspective view of head mounted display device of the present invention.

FIG. 2. is a block diagram about the focus adjustable head mounted display system of the present invention.

FIG. 3 is a block diagram about the component structure for adjusting focus according to the present invention.

FIG. 4 is a signal process flow diagram about the finger key input according to the present invention.

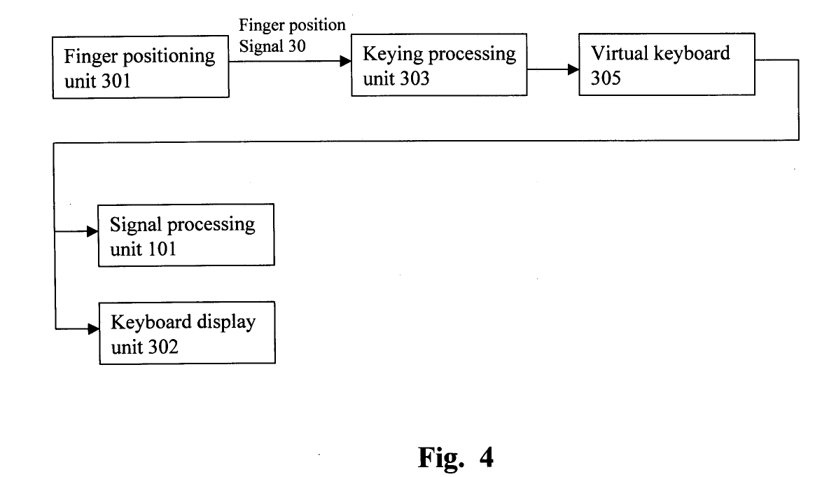

FIG. 5 is a signal process flow diagram about the sound key input according to the present invention.

FIG. 6 is a block diagram of the present invention having a keying playing unit.

FIG. 7 shows a one-display screen structure of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

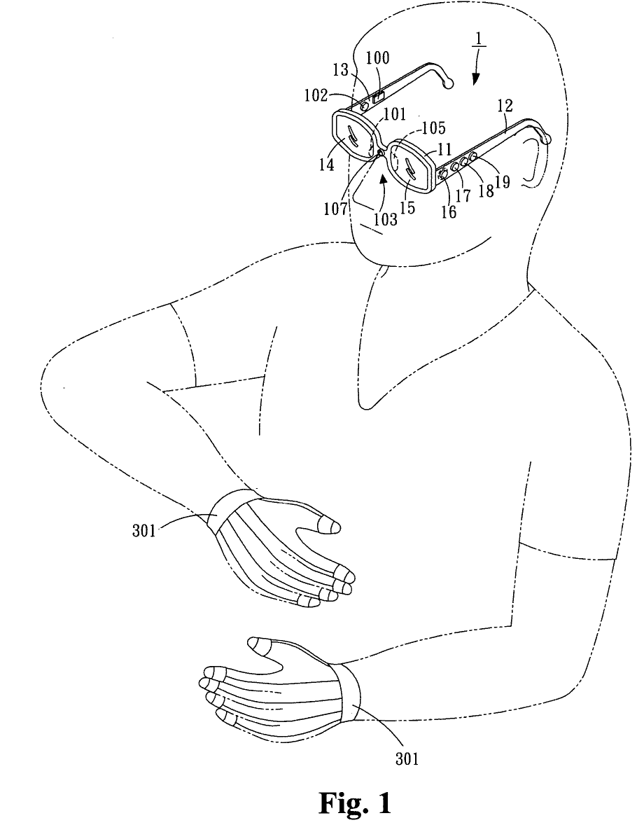

As depicted in FIG. 1, one embodiment about a head mounted display device 1 is displayed. The head mounted display device 1 can be realized as a pair of eyeglasses. The eyeglasses include a casing 11 and two temple pieces 12, and 13. The main components of the focus adjustable head mounted display system according to the present invention are mainly hidden in the casing. The casing 11 has two display screens 14, and 15 corresponding to the two eyes of the user wearing the eyeglasses.

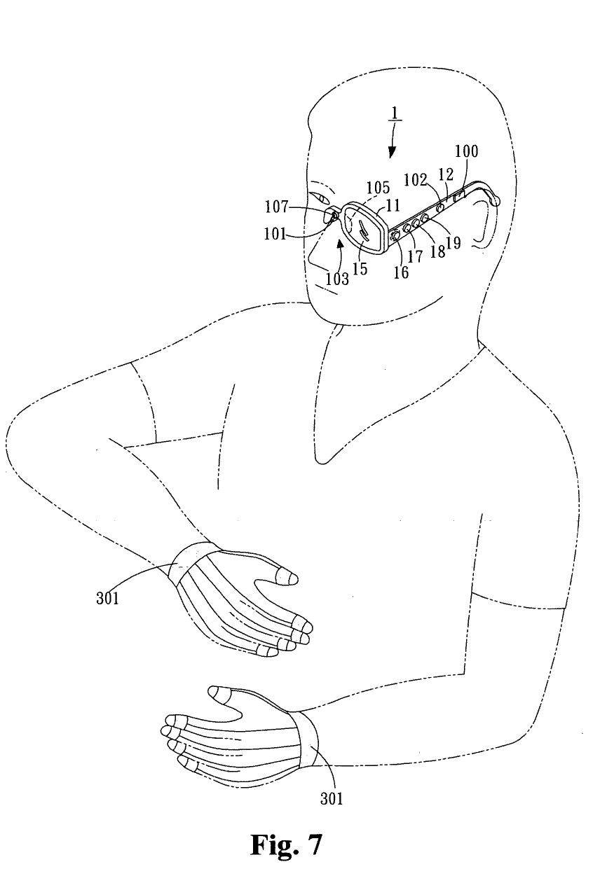

However, in the present invention, there may be only one lens and one temple piece being used in the head mounted display device, as illustrated in FIG. 7. All these are within the scope and spirit of the present invention.

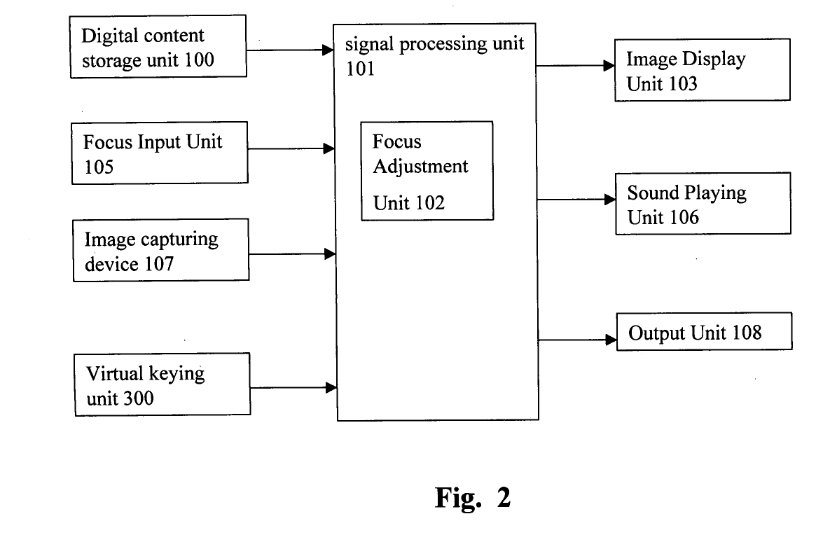

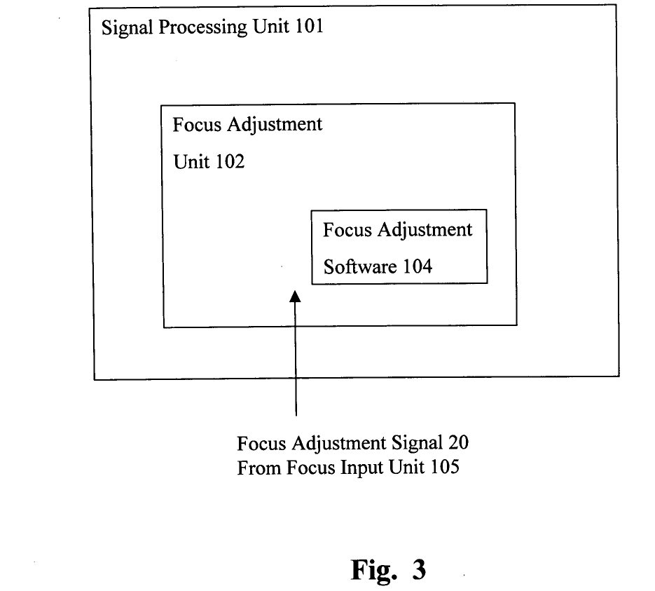

With reference to FIGS. 2 and 3, the system block diagram about the focus adjustable head mounted display system of the present invention is illustrated. The system includes an signal processing unit 101, a focus adjustment unit 102 and an image display unit 103 and a virtual keyboard input unit 300.

The signal processing unit 101 serves to perform the signal processing necessarily in the system.

The focus adjustment unit 102 is included in the signal processing unit 101 for adjusting an input image according an input focus adjustment signal 20 so that the adjusted display image responses the focus adjustment signal 20.

A focus adjustment software 104 is installed in the focus adjustment unit 102, see FIG. 3. The focus adjustment software 104 operates the input image so as to get the adjusted display image mapping to the input image with a designated focus from the focus adjustment signal 20.

The image display unit 103 is connected to the signal processing unit 101. The image display unit 103 is installed the head mounted display device for displaying the adjusted display image which is directly viewed by at least one eye of a user wearing the head mounted display.

A focus input unit 105 connected to the focus adjustment unit 102. The focus input unit 105 is a manually device. The user can adjust the focus input unit 105 so as to generate the focus adjustment signal 20 to the signal processing unit 101. The focus input unit 105 provides a focus to the focus adjustment software 104.

A sound playing unit 106 is connected to the signal processing unit 101 for emitting sound, wherein the sound playing unit may be a microphone or one or a pair of earphone.

The main feature of the present invention is that the present invention includes the virtual keyboard input unit 300. The virtual keyboard input unit 300 includes a finger positioning unit 301, a keyboard display unit 302, a keying processing unit 303 and a virtual keyboard 305.

The finger positioning unit 301 are worn upon the fingers of a user for sensing the position of the fingers, as shown in FIG. 1. Therefore, the finger position signals 30 illustrating the positions of the fingers are transferred to the keying processing unit 303. In the present invention, the finger positioning unit 301 is wired or wirelessly connected to the keying processing unit 303.

The keying processing unit 303 serves to receive the finger position signals 30 from the finger positioning unit 301. Then the position of the fingers are corresponding to respective keys and the signals of the keys are inputted to the signal processing unit 101 for processing necessary signal processing. If the key represents “a”, then a signal of “a” is inputted to the signal processing unit 101.

The keyboard display unit 302 displays the respective position of the keyboard and the positions of fingers so that the user can view of the position of fingers.

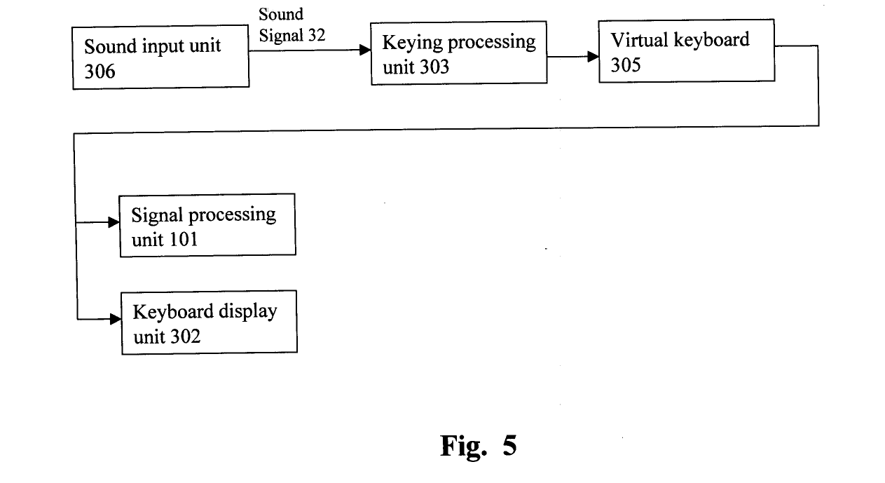

In another embodiment of the present invention, as shown in FIG. 5, the present invention further comprises a sound input unit 306, for example, a microphone, for receiving speech inputs from a user and then converts the speech into speech signals 32. Then the speech signals 32 are transferred to the keying processing unit 303. In the present invention, the sound input unit 306 is wired or wirelessly connected to the keying processing unit 303.

The keying processing unit 303 receives the speech signals 32 from the sound input unit 306 and then the speeches represented by the speech signals 32 are corresponding to the keys on the keyboard. Then the signals of the keys are inputted to the signal processing unit 101 for performing respective signal processing. If the key represents “a”, then a signal of “a” is inputted to the signal processing unit 101.

The present invention further comprises a sound playing unit 106 which is connected to the signal processing unit 101 for playing audio signals. The sound playing unit 106 may be a speaker or an earphone set.

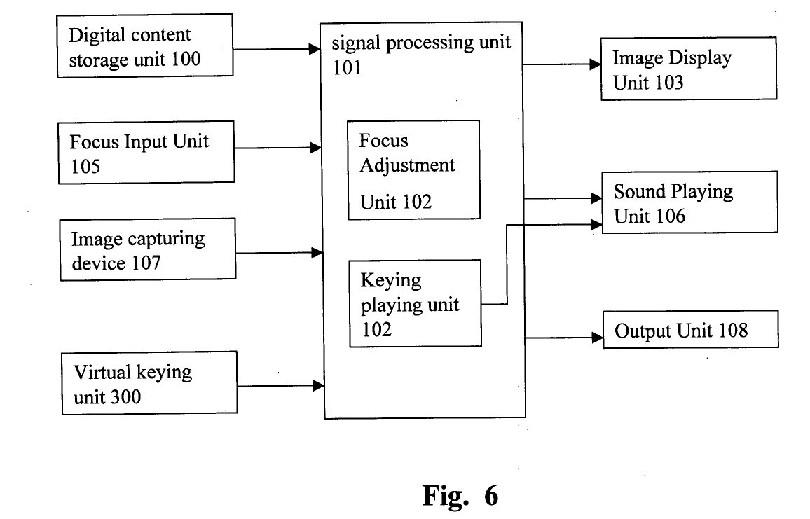

With reference to FIG. 6, the present invention further comprises key input playing means 307 which serves to convert the key input signal as a corresponding speech signal. Then the key input playing means 307 transfers the speech signal to the sound playing unit 106 to be played. Thereby, the user can know which key is inputted by sense of hearing.

It should be noted that in the present invention, the two display screens 14, 15 can present different image. For example, one display screen displays an image of a keyboard and another display screen displays an image of a normal monitor without keyboard image.

In some embodiments, it is useful to provide the user with controls. It is possible to provide controls which are not mounted on the head-mounted device (such as a remote control unit or a console) in the depicted embodiment. In the depicted embodiment, a button 16 is used to actuate the image focus adjustment signal 20 which give different focus values according to an input from the button 16. A button 17 is used to provide, for example, a mute function. Preferably, activation of this button provides for discontinuing display of the video image which is currently being output. Preferably, the mute control is configured so that the user can easily turn off at least the image, without requiring turning off of power to the HMD or interrupting the stream of data (although, in one embodiment, the mute button can be configured to simultaneously pause the data stream, such as by sending an interrupt command or other signal to a PC via the serial port). Moreover, a sound adjusting button 18 can be inclued in the present invention for adjusting the volume and other sound adjusting function.

Moreover, as shown in FIG. 1, in the present invention, the key 50 can be provided for actuating the virtual keyboard input unit 300 of the present invention.

Furthermore, a power actuation button 19 is provided for actuating the focus adjustable head mounted display system.

In operation, the user can adjust the button 16 to affect the focus input unit 105 to generate the focus adjustment signal 20 to the focus adjustment unit 102 so as to generate an adjusted display image. However, as the user finds that the adjusted display image is not clear. The user can further adjust the button 16 so as to generate another adjusted display image.

Referring to FIG. 1 again, in the embodiment of the present invention, the digital content storage unit 100, for example, a camera, is installed, preferably, in the center of the two display screen 14, 15 so as to capturing an image near a normal human view. The signal processing unit 101 is installed at the upper side of one lens, however, in the present invention, the signal processing unit 101 may be placed anywhere, for example, on the temple pieces 12, 13. Even the signal processing unit 101 is a separable piece separated from the eyeglasses. It is positioned not confined by those illustrated in the drawings.

Moreover, the inputs of the display screens of the present invention can be from a digital content storage unit 100. The digital content storage unit 100 is a memory, such as DRAM, SRAM, Flash memory, etc. for storing digital data, such as movies, songs, books, letters, short messages, web pages, notes, programs, etc. The signal processing unit 101 is connected to the digital content storage unit 100 for receiving image signals from the digital content storage unit 100 and then processing the received signals including image signals and non-image signals.

The image display unit 103 may be a projecting type display unit, namely, the display image is generated and then is projected into the display screen 14, 15 so as to get a virtual image viewed by the user. Or the image display unit 103 is a direct display unit. Namely, the image is directly input to the lenses so as to present to the user. Further, the first button 16 is installed at one upper edge of one display screen 14 and the second button 17 is installed at one upper edge of another lenses 15. However, the positions of the first and second buttons 16, 17, 18, and 19 are not confined by those depicted in FIG. 1. They can be arranged in other place of the eyeglasses. All these are within the scope and spirit of the present invention.

Referring to FIG. 2, the present invention can further include an output device 108 for outputting designated data from the signal processing unit 101 by wired connection or wirelessly.

Moreover, in the present invention, the focuses of the two eyes can be adjusted individually so as to match people having different eyesight at two eyes.

In another embodiment of the present invention, the image display unit 103 is a pair of eyeglasses. The lenses of the eyeglasses are both used as a display and a glass. In this embodiment, the button 17 serves for switching the focus adjustable head mounted display system of the present invention. As the button 17 is turned on, the focus adjustable head mounted display system will be actuated so as to actuate the digital content storage unit 100 and thus the image captured from the digital content storage unit 100 is processed and then displayed on the image display unit 103. When the button 17 is turned off, the focus adjustable head mounted display system of the present invention is turned off so that the eyeglasses are used as a normal eyeglass.

In another embodiment of the present invention, all the components are same as those in above said embodiment except that the lenses are replaced on display screens which has no function of eyeglass. Namely, the user only view the image inputted from the digital content storage unit 100.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A head mounted display system having a virtual keyboard and capable of adjusting a focus of a display screen comprising:
a signal processing unit for receiving image signals and processing the received image signals;
a focus adjustment unit included in the signal processing unit for adjusting an input image according an input focus adjustment signal to generate an adjusted display image so that the adjusted display image responses the focus adjustment signal;
an image display unit connected to the signal processing unit; the image display unit being installed at a head mounted display device for displaying the adjusted display image which is directly viewed by at least one eye of a user wearing the head mounted display; and
a focus input unit connected to the focus adjustment unit; focus input unit being a manually operation device for generating the focus adjustment signal to the signal processing unit; the focus input unit providing a focus value to the focus adjustment unit; and
a virtual keyboard input unit including a finger positioning unit, a keyboard display unit, a keying processing unit and a virtual keyboard.

2. The head mounted display system as claimed in claim 1, wherein the finger positioning unit wears upon the fingers of a user for sensing the position of the fingers, thus, the finger position signals illustrating the positions of the fingers are transferred to the keying processing unit.

3. The head mounted display system as claimed in claim 1, wherein the finger positioning unit is wired or wirelessly connected to the keying processing unit.

4. The head mounted display system as claimed in claim 1, wherein the keying processing unit serves to receive the finger position signals from the finger positioning unit; then the position of the fingers are corresponding to respective keys and the signals of the keys are inputted to the signal processing unit for processing necessary signal processing.

5. The head mounted display system as claimed in claim 1, wherein the keyboard display unit displays the respective position of the keyboard and the positions of fingers so that the user can view of the position of fingers.

6. The head mounted display system as claimed in claim 1, further comprising a sound input unit for receiving speech inputs from a user and then converts the speech into speech signals; then the speech signals are transferred to the keying processing unit.

7. The head mounted display system as claimed in claim 1, wherein the sound input unit is a microphone.

8. The head mounted display system as claimed in claim 1, wherein the sound input unit is wired or wirelessly connected to the keying processing unit.

9. The head mounted display system as claimed in claim 6, wherein the keying processing unit receives the speech signals from the sound input unit and then the speeches represented by the speech signals are corresponding to the keys on the keyboard; then the signals of the keys are inputted to the signal processing unit for performing respective signal processing.

10. The head mounted display system as claimed in claim 6, further comprising a sound playing unit which is connected to the signal processing unit for playing audio signals.

11. The head mounted display system as claimed in claim 10, wherein the sound playing unit is one of a speaker or an earphone set.

12. The head mounted display system as claimed in claim 1, further comprising a key input playing means which serves to convert the key input signal as a corresponding speech signal; then the key input playing means transfer the speech signal to the sound playing unit to be played.

13. The head mounted display system as claimed in claim 1, wherein the focus adjustment unit includes a focus adjustment software; the focus adjustment software operates the input image so as to get the adjusted display image mapping to the input image with a designated focus from the focus adjustment signal.

14. The head mounted display system as claimed in claim 1, further comprising an image capturing device for capturing environmental images which are then processed through the signal processing unit and then displayed on display screens.

15. The head mounted display system as claimed in claim 1, further comprising a digital content storage unit for storing digital data.

16. A head mounted display device having a virtual keyboard and capable of adjusting a focus of a display screen comprising:
a casing for containing some elements of the head mounted display device;
at least one temple piece;
a signal processing unit for receiving image signals from the digital content storage unit and processing the received image signals; signal processing unit comprising a focus adjustment unit; and
an image display unit connected to the signal processing unit; the image display unit including at least one display screen corresponding to eyes of a user wearing the head mounted display device; and
a focus input unit connected to the focus adjustment unit for generating a focus adjustment signal to the signal processing unit; and the focus input unit providing a focus value to the focus adjustment software;
a finger positioning unit wearing upon the fingers of a user for sensing the position of the fingers, thus, the finger position signals illustrating the positions of the fingers are transferred to the keying processing unit; and
a keying processing unit serving to receive the finger position signals from the finger positioning unit; then the position of the fingers are corresponding to respective keys and the signals of the keys are inputted to the signal processing unit for processing necessary signal processing.
